(19) United States
(12) Patent Application Publication
(10) Pub. No.: US 2016/0001672 A1
(43) Pub. Date: Jan. 7, 2016

(54) EQUIVALENT CIRCUIT BASED BATTERY CURRENT LIMIT ESTIMATIONS

(71) Applicant: FORD GLOBAL TECHNOLOGIES, LLC, Dearborn, MI (US)

(72) Inventor: Tae-Kyung LEE, Ann Arbor, MI (US)

(21) Appl. No.: 14/321,204

(22) Filed: Jul. 1, 2014

(51) Int. Cl. B60L 11/18; H02J 7/00

(52) U.S. Cl. CPC B60L 11/1864; H02J 7/0063; H02J 7/007

(57) ABSTRACT

A battery system includes a plurality of battery cells and a controller. The controller outputs a plurality of current limits for the cells, and controls operation of the cells according to the current limits. Each of the current limits has a different time duration and is based on state variables from an equivalent circuit model of the cells. The state variables are based on terminal voltage and output current data associated with the cells.

### TECHNICAL FIELD

The present disclosure relates to battery management techniques capable of estimating parameters of elements forming a battery model for providing control of an associated battery.

### BACKGROUND

Hybrid electric vehicles (HEV) utilize a combination of an internal combustion engine with an electric motor to provide motive power. This arrangement provides improved fuel economy over a vehicle that has only an internal combustion engine. One method of improving the fuel economy in an HEV is to shutdown the engine during times that the engine operates inefficiently, and is not otherwise needed to propel the vehicle. In these situations, the electric motor is used to provide all of the power needed to propel the vehicle. When the driver power demand increases such that the electric motor can no longer provide enough power to meet the demand, or in other cases such as when the battery state of charge (SOC) drops below a certain level, the engine should start quickly and smoothly in a manner that is nearly transparent to the driver.

The HEV includes a battery management system that estimates values descriptive of the battery pack and/or battery cell present operating conditions. The battery pack and/or cell operating conditions include battery SOC, power fade, capacity fade, and instantaneous available power. The battery management system should be capable of estimating values during changing cell characteristics as cells age over the lifetime of the pack.

### SUMMARY

A vehicle battery management system includes a battery pack and at least one controller. The at least one controller controls operation of the battery pack according to first and second current limits that are based on state variables from an equivalent circuit model of the battery pack. A time duration of the second current limit is at least an order of magnitude greater than a time duration of the first current limit.

### BRIEF DESCRIPTION OF THE DRAWINGS

FIG. 1 is a schematic diagram of a hybrid-electric vehicle illustrating typical drivetrain and energy storage components;

FIG. 2 is a graph illustrating an Electrical Impedance Spectroscopy Nyquist plot of battery impedance;

FIG. 3 is a schematic diagram of an equivalent circuit model using one RC circuit to model a battery;

FIG. 4 is a graph illustrating frequency responses of the equivalent circuit model with one RC circuit in the Nyquist plot;

FIG. 5 is a schematic of an equivalent circuit model using two RC circuits to model a battery;

FIG. 6 is a graph illustrating the calculated battery impedance in the Nyquist plot using two RC circuits in the equivalent circuit model;

FIGS. 7A-7C are graphs illustrating predicted battery responses using an equivalent circuit model having one RC circuit compared to the two RC circuit model;

FIG. 8 are graphs illustrating the calculated battery state variables in the two RC circuit equivalent circuit model;

FIG. 9A is a graph illustrating predicted instantaneous battery current limits for charging and discharging based on an equivalent circuit model having one RC circuit;

FIG. 9B is a graph illustrating predicted instantaneous and continuous battery current limits for charging and discharging based on an equivalent circuit model having two RC circuits; and

FIG. 10 is a flow chart of an algorithm for estimating instantaneous and continuous battery current limits and power limits in a battery management system.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The embodiments of the present disclosure generally provide for a plurality of circuits or other electrical devices. All references to the circuits and other electrical devices and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof) and software which co-act with one another to perform operation(s) disclosed herein. In addition, any one or more of the electric devices may be configured to execute a computer-program that is embodied in a non-transitory computer readable medium that is programmed to perform any number of the functions as disclosed.

An HEV battery system may implement a battery management strategy that estimates values descriptive of the present operating condition of the battery and/or one or more battery cells. The battery pack and/or one or more cell operating conditions include battery state of charge, power fade, capacity fade, and instantaneous available power. The battery management strategy may be capable of estimating values as cells age over the lifetime of the pack. The precise estimation of some parameters may improve performance and robustness, and may ultimately lengthen the useful lifetime of the battery pack. For the battery system described herein, estimation of some battery pack and/or cell parameters can be realized as discussed below.

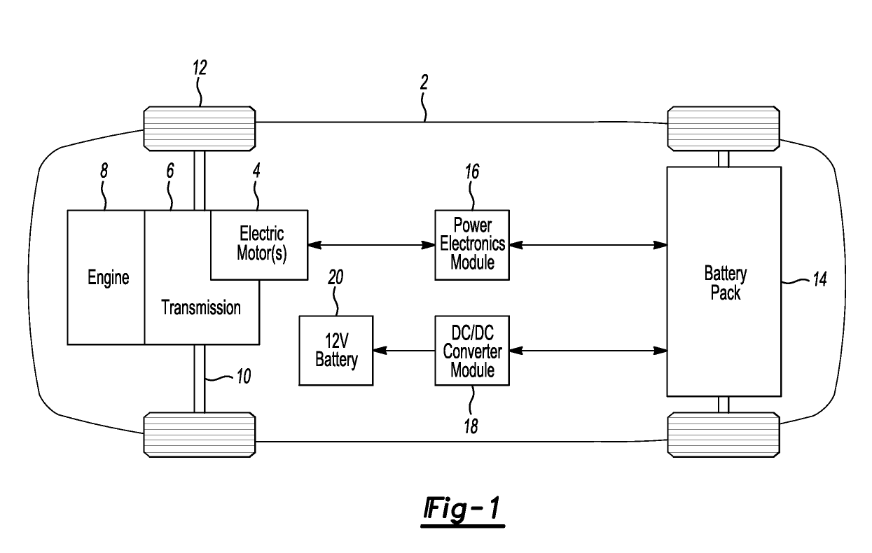

FIG. 1 depicts a typical hybrid-electric vehicle. A typical hybrid-electric vehicle 2 may comprise one or more electric motors 4 mechanically connected to a hybrid transmission 6. In addition, the hybrid transmission 6 is mechanically connected to an engine 8. The hybrid transmission 6 is also mechanically connected to a drive shaft 10 that is mechanically connected to the wheels 12. In another embodiment not depicted in the illustration, the hybrid transmission may be a non-selectable gear transmission that may include at least one electric machine. The electric motors 4 can provide propulsion and deceleration capability when the engine 8 is turned on or off. The electric motors 4 also act as generators and can provide fuel economy benefits by recovering energy that would normally be lost as heat in the friction braking system. The electric motors 4 may also provide reduced pollutant emissions since the hybrid electric vehicle 2 may be operated in electric mode under certain conditions.

A battery pack 14 may include a traction battery having one or more battery cells that store energy which can be used by the electric motors 4. The vehicle battery pack 14 typically provides a high voltage DC output and is electrically connected to a power electronics module 16. The power electronics module 16 may communicate with one or more control modules that make up a vehicle computing system 22. The vehicle computing system 22 may control several vehicle features, systems, and/or subsystems. The one or more modules may include, but are not limited to, a battery management system. The power electronics module 16 is also electrically connected to the electric motors 4 and provides the ability to bi-directionally transfer energy between the battery pack 14 and the electric motors 4. For example, a typical battery pack 14 may provide a DC voltage while the electric motors 4 may require three-phase AC current to function. The power electronics module 16 may convert the DC voltage to a three-phase AC current as required by the electric motors 4. In a regenerative mode, the power electronics module 16 will convert the three-phase AC current from the electric motors 4 acting as generators to the DC voltage required by the battery pack 14.

In addition to providing energy for propulsion, the battery pack 14 may provide energy for other vehicle electrical systems. A typical system may include a DC/DC converter module 18 that converts the high voltage DC output of the battery pack 14 to a low voltage DC supply that is compatible with other vehicle loads. Other high voltage loads may be connected directly without the use of a DC/DC converter module 18. In a typical vehicle, the low voltage systems are electrically connected to a 12V battery 20.

The battery pack 14 may be controlled by the power electronics module 16 which may receive commands from a vehicle computing system 22 having one or more control modules. The one or more control modules may include a battery control module. The one or more control modules may be calibrated to control the battery pack 14 using a battery model parameter estimation method which estimates an average sense of effective battery internal resistance during operation to determine battery power capability. The power capability prediction enables the battery pack 14 to prevent over-charging and over-discharging.

The battery parameter prediction method and/or strategy may assist in determining battery current limits and power capability in real-time (i.e., during operation). Many battery parameter estimation processes are affected by the fidelity of battery models and unpredicted environmental conditions or unexpected noises during battery operations. For example, if a battery is in a charge depleting mode, a simple battery model may not capture complicated system dynamics associated with voltage output and current input they are trying to measure. The vehicle battery measurement method/strategy may use the equivalent circuit model using one or more resistant-capacitor (RC) circuits in several configurations to measure the battery pack in the vehicle to obtain the electrochemical impedance during operation.

The calibration to control the battery pack may be accomplished using multiple tables to capture a wide frequency range that affects the impedance of the battery pack and its correlating dynamics. To populate/calibrate the multiple tables requires rigorous execution of offline testing of the battery pack in a test facility using complex algorithms. An example of offline testing of a battery pack is the Electrochemical Impedance Spectroscope (EIS) which may be implemented to capture the battery system characterization over wide frequency ranges that may include battery temperature, battery state of charge, and/or battery usage.

A vehicle battery measurement method may be implemented to eliminate the need for extensive offline testing. The vehicle battery measurement method may use one or more simple equivalent circuits to measure the battery pack in the vehicle to obtain the electrochemical impedance during operation. The on-board battery parameter estimation methods may have a higher level of noise compared to off-line parameter estimations. They, however, may provide valuable information regarding battery transient behavior during vehicle operation.

The HEV battery management system may implement the equivalent circuit model to predict battery performance using battery parameters for the next few seconds based on the battery measurements and the estimated electrochemical impedance. The estimated battery parameters may change depending on the driving conditions and electrified vehicle operating modes, such as charge sustaining mode, or charge depleting mode. The battery parameter estimation procedure using a simple equivalent circuit model tends to be sensitive to internal and external noises and environmental conditions.

A system may use the battery measurements to estimate the battery model parameters and subsequently to calculate battery power capability using the estimated model parameters. Battery power capability is affected by the impedance of the battery pack and its correlating dynamics. The battery model parameter estimation method may include battery measurement in the vehicle to obtain the electrochemical impedance with the use of an Extended Kalman Filter and other calculations/algorithms described in further detail below to calculate battery power capability. The power capability of a battery may be determined by state variables and may be inferred by using system inputs and outputs.

A model-based battery management system, based on equivalent circuit models, provides sufficient computation speed manageable in the battery management system without introducing additional hardware and/or increasing the system complexity. The characterization of the battery system may be calculated by real-time parameter estimation approaches on battery models using direct battery measurements in a HEV. The system may measure the battery current inputs and battery terminal voltage. The measurement values may be recorded, calculated, and stored in one or more control modules in the vehicle computing system including the battery energy control module.

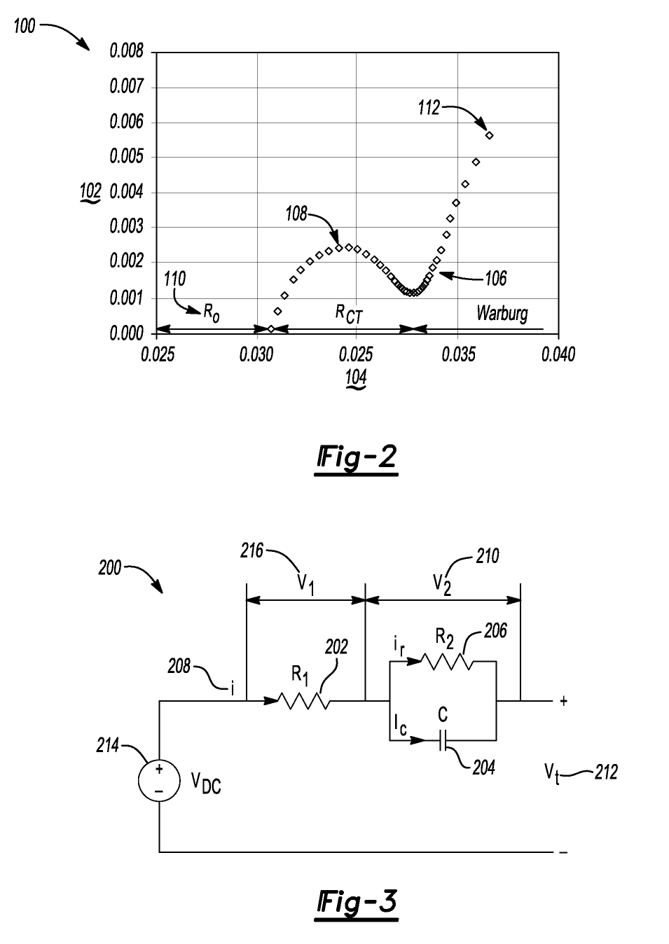

FIG. 2 is a graph 100 illustrating an EIS Nyquist plot of battery impedance with respect to frequency. The EIS Nyquist plot 100 illustrates a direct physical interpretation of the battery system using one equivalent circuit. The EIS Nyquist plot 100 has an x-axis representing real impedance 104 and a y-axis representing imaginary impedance 102. The curve 106 illustrates a measured impedance of the battery over a range of frequencies. The range of frequency responses of the system may reveal the energy storage and dissipation properties of the battery.

The EIS Nyquist plot 100 may reveal information about the reaction mechanism of an electrochemical process for the battery including different reaction steps that may dominate at certain frequencies, and the frequency response may help to identify the rate limiting steps. The curve 106 may represent the slow battery dynamic response caused by diffusion processes at the solid particle of the electrode active materials and polarization processes across the cell thickness. The instantaneous responses are determined by an internal resistance term R₀ 110 of an equivalent circuit model of the battery. Battery dynamics represented by a medium-to-high frequency 108 mainly determine the power capability with the consideration of battery dynamics. The slow dynamics represented by a low frequency 112 (e.g., Warburg Impedance Term) and instantaneous dynamics represented by R₀ 110 are modeled as the real-time adjusting internal resistance in the equivalent circuit model. The graph 100 captures the battery dynamic responses that may be used to estimate instantaneous battery power capability of the battery system.

FIG. 3 is a schematic of an equivalent circuit with one RC circuit to model a battery. The circuit may model a battery including a battery pack and/or one or more battery cells. The equivalent circuit model consists of an active electrolyte resistance (or internal resistance) R₀ 202, in series with the parallel capacitance C₁ 204, and an active charge transfer resistance R₁ 206. The battery dynamics and related state variables are expressed as the terminal voltage output vᵣ 212, v_{OC} 214 battery open circuit voltage, v₀ 216 internal battery voltage, and v₁ 210 the voltage of the RC circuit. The model may be implemented in a HEV battery management system to provide predictive computations for one or more battery parameters.

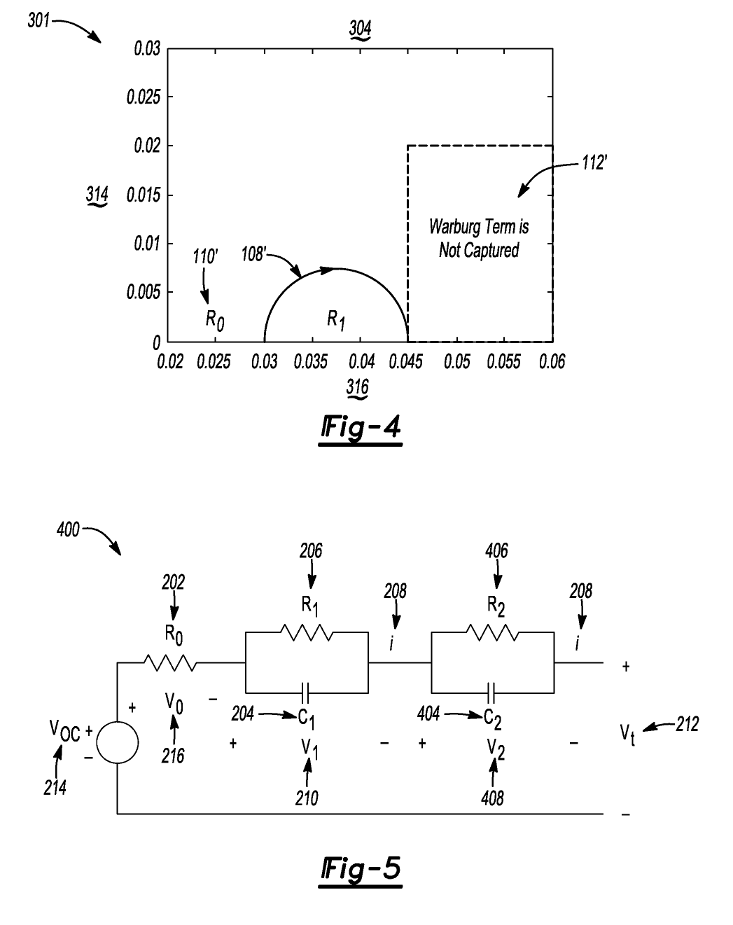

FIG. 4 is a graph 301 illustrating frequency responses of the equivalent circuit model with one RC circuit in the Nyquist plot. The x-axis 316 of the graph 301 represents a real part of the average battery impedance within a time window. The y-axis 314 of the graph 301 represents an imaginary part of the average electrical impedance for the cell. The medium-to-fast dynamics are represented by the semi-circuit 108′ generated from the RC circuit (i.e., R₁ and C₁) and the internal resistance is related to R₀ 110′. However, the slow dynamics, called a Warburg term 112′, are not captured by the equivalent circuit model with one RC circuit. Thus, slow dynamics, herein known as the Warburg term 112′, may not effectively be represented in the one RC circuit model.

FIG. 5 is a schematic of a simple equivalent circuit model 400 using two RC circuits to model a battery according to an embodiment. The two RC circuits may improve the modeling 400 of the battery pack and/or one or more battery cells by introducing additional dynamics to the model. For instance, the slow dynamics term 112 may be modeled using an additional RC circuit. The two RC circuit models may include an additional RC circuit having a resistor R₂ 406 and capacitor C₂ 404 in parallel with each other and collectively in series with the RC circuit in the equivalent circuit model 200 in FIG. 3. The equivalent circuit model may include more than two RC circuits.

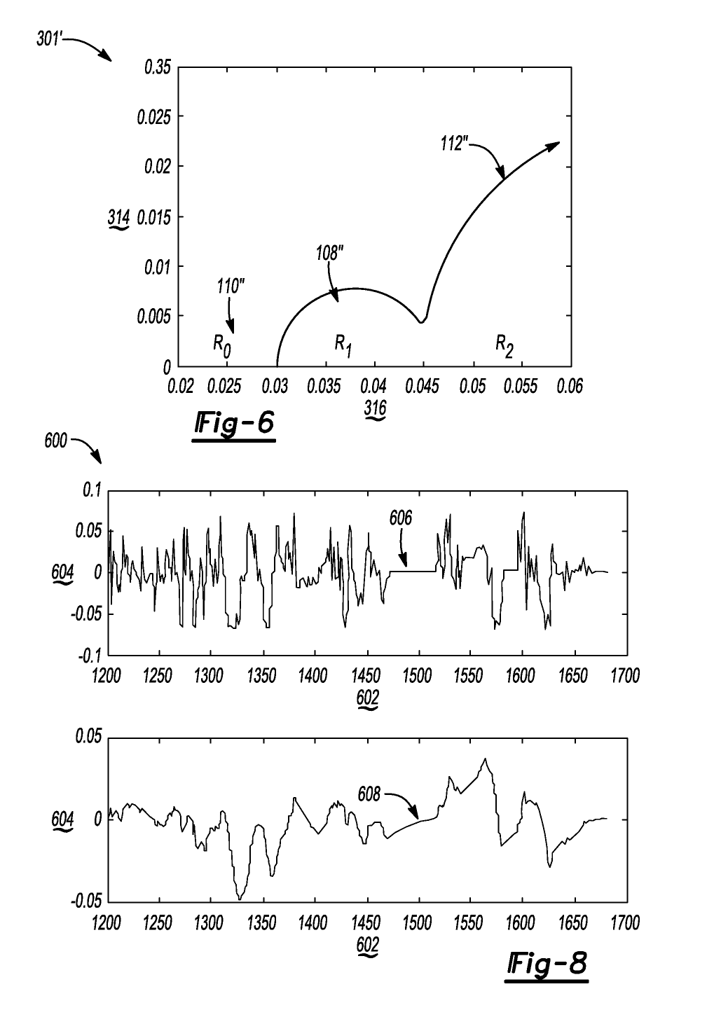

FIG. 6 is a graph 301′ illustrating a calculation of an average internal resistance of one or more battery cells using two or more RC circuits in the equivalent circuit model according to an embodiment. The horizontal axis 316 of the graph 301′ represents a real part of the average battery impedance within a time window. The vertical axis 314 of the graph 301′ represents an imaginary part of the average electrical impedance for the cell.

The graph 301′ illustrates the system capturing the average internal resistance relying on high frequency 108″ as a component of the electric impedance of the one or more cells. The system may capture the low frequency 112″ component of the electric impedance of the one or more cells with the use of two or more RC circuits in the equivalent circuit model. The system may estimate the battery current limits and power capability with improved fidelity under wide frequency range operations, specifically for the vehicle operation case that the slow dynamics becomes a state of the battery operation.

For example, the medium-to-fast dynamics are represented by the semi-circuit 108″ generated from the RC circuit (i.e., R₁ and C₁) and the internal resistance is related to R₀ 110″. The slow dynamics, called a Warburg term 112″, is captured by the equivalent circuit model with the additional RC circuit (i.e., R₂ and C₂). Thus slow dynamics, herein known as the Warburg term 112″, are demonstrated in the equivalent circuit model using two or more RC circuits.

A vehicle battery measurement method may implement the simple equivalent circuit model 400 using two RC circuits to capture fast and slow dynamics independently. The two RC circuits may improve prediction capability for low temperature and/or long continuous charging conditions. The Randles Circuit Model 200 as shown in FIG. 3 may not capture slow battery dynamics related to the Warburg Impedance Terms. The two RC circuits may improve the modeling of the battery dynamics by capturing both low frequency and medium-to-high frequency responses using the following equations:

$${\dot{v}}_{1} = - \frac{1}{{R}_{1} {C}_{1}} {v}_{1} + \frac{1}{{C}_{1}} i \qquad ( 1 )$$

where v₁ 210 is the voltage across the RC circuit which consists of resistance R₁ and capacitor C₁, the resistance R₁ 206 is an active charge transfer resistance, and i 208 is the current exciting the circuit. The RC circuit which consists of resistor R₁ and capacitor C₁ represents battery dynamics changing during vehicle operation. The RC circuit which consists of resistor R₂ and capacitor C₂ represents battery slow dynamics (i.e., low frequency) during vehicle operation using the following equation:

$${\dot{v}}_{2} = - \frac{1}{{R}_{2} {C}_{2}} {v}_{2} + \frac{1}{{C}_{2}} i \qquad ( 2 )$$

where \dot{v}₂ 210 is the voltage across the RC circuit which consists of R₂406 and C₂ 404, i 208 is the current exciting the circuit. The additional RC circuit having resistor R₂ 406 and capacitor C₂ represents low frequency during vehicle operation.

The equivalent circuit model having two RC circuits may allow the calculation of the battery terminal voltage using the following equation:

vₜ=v_{oc}−v₁−v₂−R₀i (3)

where vₜ 212 is the terminal voltage, v_{oc} 214 is the battery open circuit voltage, v₁ 210 is the voltage across the RC circuit which consists of resistance R₁ and capacitor C₁, v₂ 210 is the voltage across the RC circuit which consists of R₂ 406 and C₂ 404, and R₀ 202 is the internal battery resistance. The voltage across the RC circuits may be calculated using the following equations:

$$\begin{matrix}{v}_{1} = {v}_{1 , 0} {e}^{- \frac{t}{{R}_{1} {C}_{1}} t} + ( 1 - {e}^{- \frac{1}{{R}_{1} {C}_{1}} t} ) {R}_{1} i & ( 4 ) \\ {v}_{2} = {v}_{2 , 0} {e}^{- \frac{t}{{R}_{2} {C}_{2}} t} + ( 1 - {e}^{- \frac{1}{{R}_{2} {C}_{2}} t} ) {R}_{2} i & ( 5 )\end{matrix}$$

The battery terminal voltage estimation with multiple RC equivalent circuit models is derived as the following equation:

$${v}_{t} = {v}_{OC} - {v}_{1 , 0} {e}^{- \frac{t}{{R}_{1} {C}_{1}} t} - {v}_{2 , 0} {e}^{- \frac{t}{{R}_{2} {C}_{2}} t} - ( {R}_{0} + ( 1 - {e}^{- \frac{t}{{R}_{1} {C}_{1}} t} ) {R}_{1} + ( 1 - {e}^{- \frac{t}{{R}_{2} {C}_{2}} t} ) {R}_{2} ) i \qquad ( 6 )$$

where t is time. The battery current limit during the duration of t_{d} is derived from eqn. (6) as the following equation:

$$i = \frac{{v}_{OC} - {v}_{lim} - {v}_{1 , 0} {e}^{{ }^{- \frac{t}{{R}_{1} {C}_{1}} {t}_{d}}} - {v}_{2 , 0} {e}^{{ }^{- \frac{t}{{R}_{2} {C}_{2}} {t}_{d}}}}{{R}_{0} + ( 1 - {e}^{- \frac{t}{{R}_{1} {C}_{1}}} ) {R}_{1} + ( 1 - {e}^{- \frac{t}{{R}_{2} {C}_{2}}} ) {R}_{2}} \qquad ( 7 )$$

where t_{d} is time duration (i.e., a time window) for a period of time, and vₗᵢₘ is the battery voltage limits. For discharging, vₗᵢₘ is the lower limit v_{lb}, and for charging, vₗᵢₘ is the upper limit v_{ub}.

The battery current limit computation may be simplified or separated in different time domains. For instance, the current limits may be defined during the instantaneous duration, i.e., short time duration, such as 1 second. The current limits may be defined during long durations referred to as a continuous time duration, such as 60 seconds or longer.

The battery management system may use the current limit information to use battery power and energy effectively. The prediction accuracy of the current limits using fast and slow dynamics frequency may be improved by a multiple RC equivalent circuit model. The battery current limits in different time domains may be calculated with reduced complexity under certain conditions.

For fast dynamics, let τ₁=R₁C₁ and τ₂=R₂C₂. If

$${τ}_{1} ≪ {τ}_{2} and \frac{{t}_{d}}{{τ}_{2}} ≪ 1 ,$$

the current limits may be computed by using the following equation without producing significant estimation errors:

$$i = \frac{{v}_{OC} - {v}_{lim} - {v}_{2 , 0} - {v}_{1 , 0} {e}^{{ }^{- \frac{t}{{R}_{1} {C}_{1}} {t}_{d}}}}{{R}_{0} + ( 1 - {e}^{{ }^{- \frac{t}{{R}_{1} {C}_{1}} {t}_{d}}} ) {R}_{1}} \qquad ( 8 )$$

For continuous current limits, for example t_{d}=10 minutes=600 seconds, slow dynamics are dominant, therefore,

$$\frac{{t}_{d}}{{τ}_{1}} ≫ 1.$$

The estimation errors for slow dynamics may be dampened by using the following equation:

$$i = \frac{{v}_{OC} - {v}_{lim} - {v}_{2 , 0} {e}^{{ }^{- \frac{t}{{R}_{2} {C}_{2}} {t}_{d}}}}{{R}_{0} + {R}_{1} + ( 1 - {e}^{{ }^{- \frac{t}{{R}_{2} {C}_{2}} {t}_{d}}} ) {R}_{2}} \qquad ( 9 )$$

The equations (8) and (9) may produce conservative results in estimating current limits due to the assumption. In other words, the computed current limits may be slightly less than the real number. This underestimation is beneficial in battery management system since the safety margin may be inherently included from the introduced assumptions.

The general expression of the power limit estimation with multiple RC circuits for instantaneous current limits is derived as the following equation:

$$i = \frac{{v}_{OC} - {v}_{lim} - {v}_{2 , 0} - … - {v}_{n , 0} - {v}_{1 , 0} {e}^{{ }^{- \frac{t}{{R}_{1} {C}_{1}} {t}_{d}}}}{{R}_{0} + ( 1 - {e}^{{ }^{- \frac{t}{{R}_{1} {C}_{1}} {t}_{d}}} ) {R}_{1}} \qquad ( 10 )$$

The system may calculate the battery instantaneous power capabilities during a discharge event using the following equation:

Pₗᵢₘ=|iₘᵢₙ|v_{ub} (11a)

where Pₗᵢₘ is the power capability, v_{ub} is the battery upper voltage limit, and iₘᵢₙ is the absolute minimum current. The system may calculate the battery instantaneous power capabilities during a charging event using the following equation:

Pₗᵢₘ=|iₘₐₓ|v_{lb} (11b)

where Pₗᵢₘ is the power capability, v_{lb} is the battery lower voltage limit, and iₘₐₓ is the maximum current.

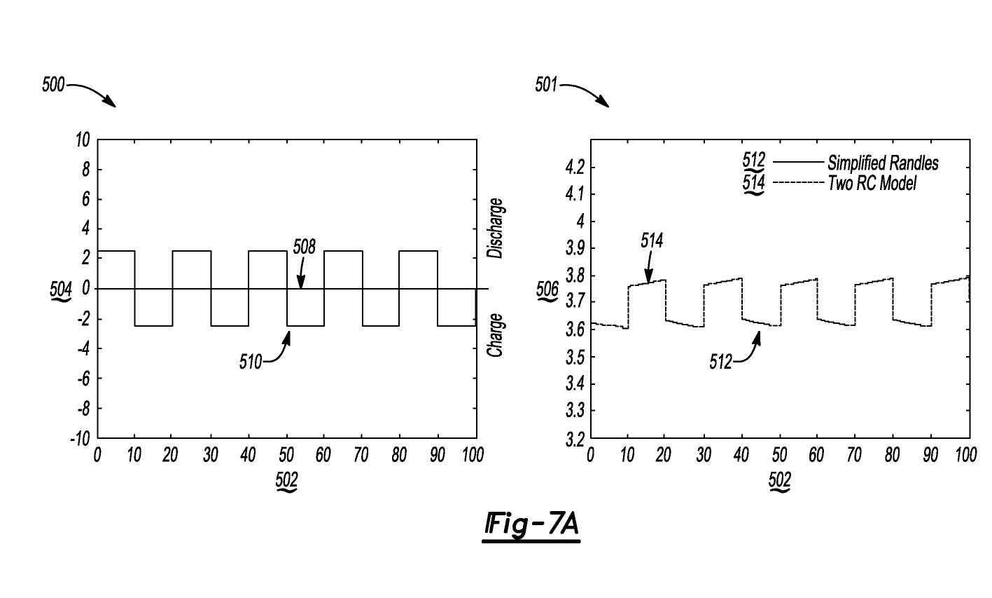

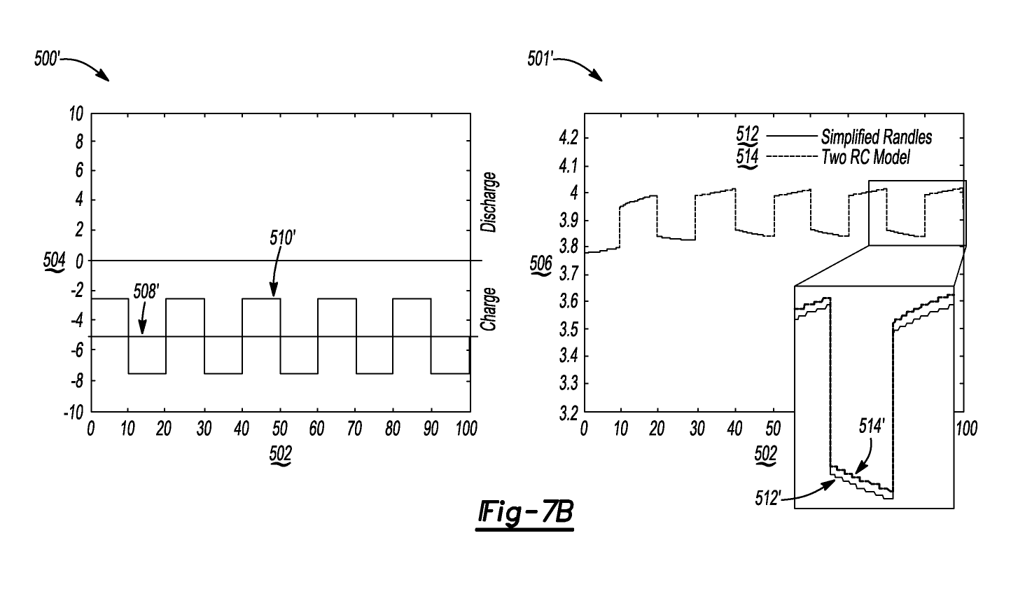

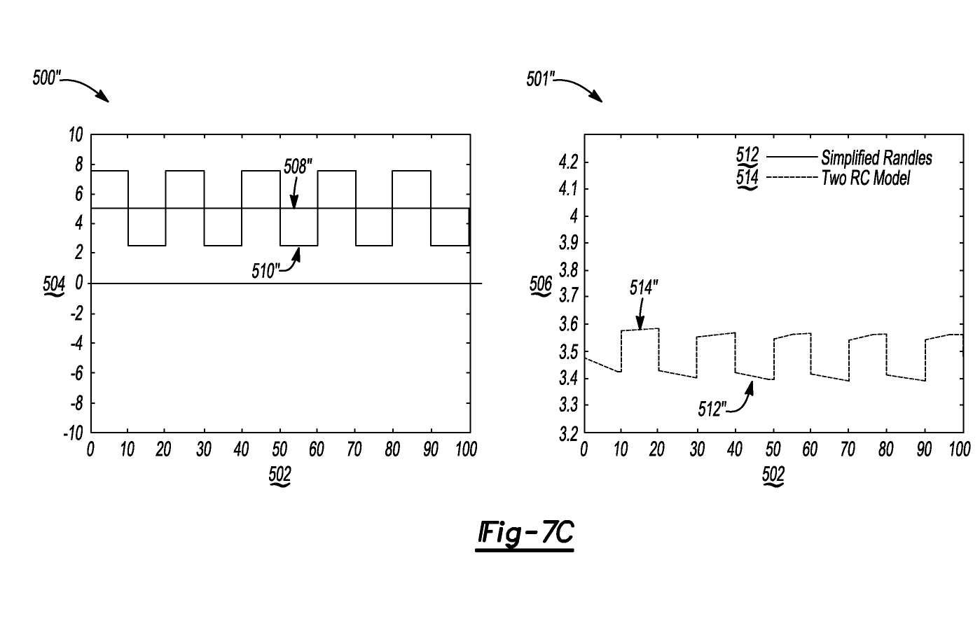

FIGS. 7A-7C are graphs illustrating predicted battery responses using an equivalent circuit model having one RC circuit compared to the two RC circuit model. The graphs in FIGS. 7A-7C have an x-axis 502 representing time and a y-axis that may represent either current 504 for the current input graph 500 or terminal voltage 506 for the terminal voltage graph 501.

FIG. 7A is a graph illustrating predicted battery response for a balanced charging and discharging of the battery. As shown in the current input graph 500, the mean current 508 is at zero amps while having a magnitude of current 510 equal to 2.5 amperes. The corresponding terminal voltage graph 501 illustrates that the equivalent circuit model predicted voltages are almost comparable to the two RC circuit model predicted voltages.

FIG. 7B is a graph illustrating predicted battery response for an offset charging and discharging of the battery when the charging is dominant. As shown in the current input graph 500′, the mean current 508′ is at negative five (−5) amps while having a magnitude of current 510′ equal to 2.5 amperes. The corresponding terminal voltage graph 501′ illustrates that the one RC equivalent circuit model predicted voltages are not as accurate as the two RC circuit model predicted voltages. The RC circuit model predicted voltages may capture the slow dynamics of the battery during vehicle operation; therefore the difference as shown in the graph of FIG. 7B becomes evident as time goes on.

FIG. 7C is a graph illustrating predicted battery response for an offset charging and discharging of the battery when the discharging is dominant. As shown in the current input graph 500″, the mean current 508″ is at five amperes while having a magnitude of current 510″ equal to 2.5 amps. The corresponding terminal voltage graph 501″ illustrates that the one RC circuit model predicted voltages are almost comparable to the two RC circuit model predicted voltages.

FIG. 8 depicts graphs illustrating the calculated battery state variables in the two RC circuit equivalent circuit model. The graphs 600 in FIG. 8 have an x-axis representing time 602 and a y-axis representing voltage 604. The state variables are the voltage values 210 across the first RC circuit and the voltage 408 across the second RC circuit. The equivalent circuit model having two RC circuits may capture the fast dynamics using a first RC circuit while calculating slow dynamics using the second RC circuit in series with the first. The battery power limits may be calculated based on the voltage values calculated across each RC circuit and model parameters.

As shown in FIG. 8, different frequency dynamics are captured respectively by the first RC circuit v₁ 606 and the second RC circuit v₂ 608. The voltage v₁ 606 may represent the fast dynamics, and the voltage v₂ 608 may represent the slow dynamics. The voltage responses may be used to estimate battery current limits, battery power capability and other battery performance variables.

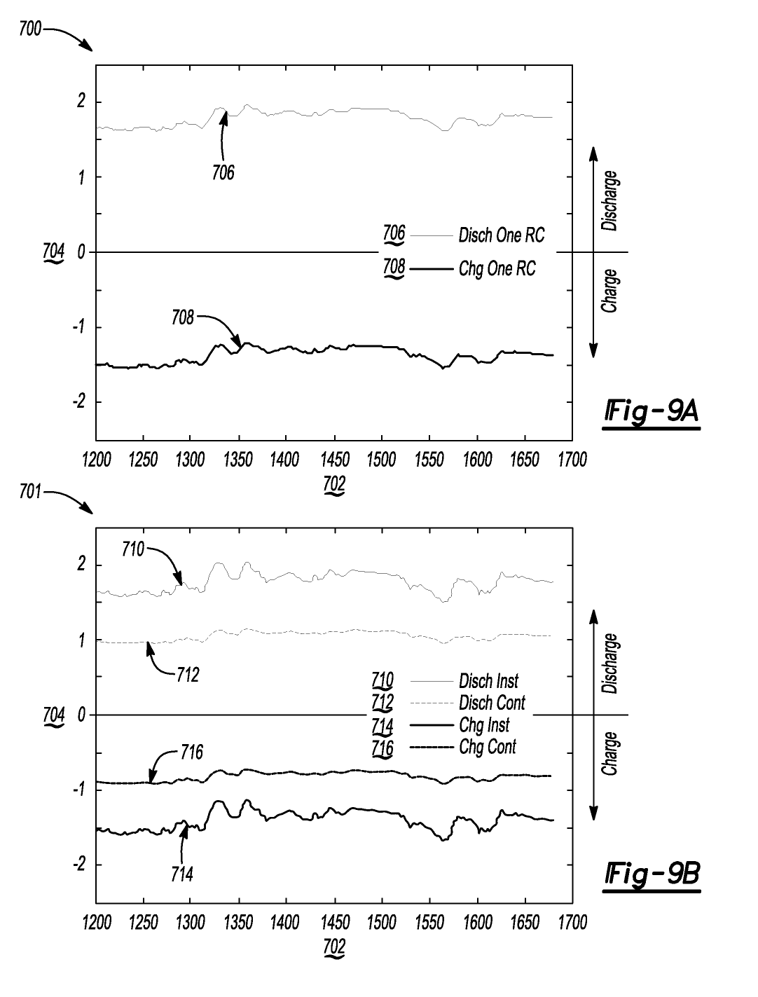

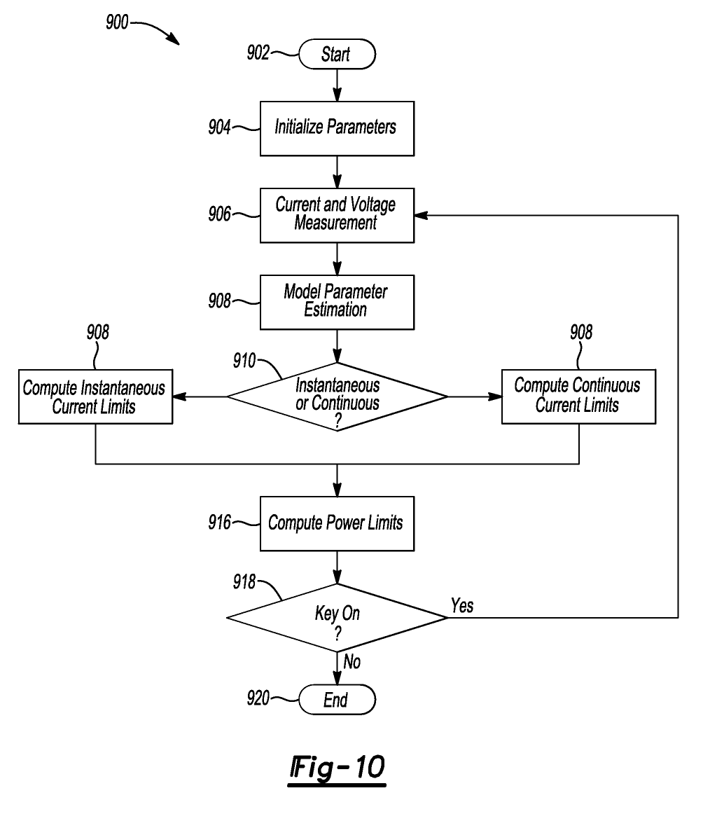

FIGS. 9A-9B depict graphs illustrating predicted instantaneous and continuous current based on the equivalent circuit models. The graphs in FIGS. 9A-9B have an x-axis 702 representing time and a y-axis 704 representing normalized current measured in amperes.

FIG. 9A depicts a graph 700 illustrating predicted instantaneous battery current limits for charging and discharging based on an equivalent circuit model having one RC circuit. As illustrated in the graph 700, the discharging current 706 and the charging current 708 are based on the fast dynamics of the battery, and the slow dynamics are not captured effectively due to the lack of RC circuits to represent the slow dynamics. Therefore, the continuous available current based on the discharge current 706 and charge current 708 may not be computed with good accuracy under certain slow dynamics dominant operating conditions.

FIG. 9B depicts a graph 701 illustrating predicted instantaneous and continuous battery current limits for charging and discharging based on an equivalent circuit model having two RC circuits. The system may capture the high frequency and low frequency based on the dynamic responses of the battery using two RC circuits. The system may calculate an instantaneous maximum discharge/charge current 710 and a continuous maximum discharge/charge current 712 based on the estimated battery states, v₁ and v₂, and battery model parameters based on equations 8 and 9 respectively.

FIG. 10 is a flow chart 900 of an algorithm for estimating instantaneous and continuous battery current limits and power limits in a battery management system. The method is implemented using software code contained within the vehicle control module, according to one or more embodiments. In other embodiments, the method 900 is implemented in other vehicle controllers, or distributed amongst multiple vehicle controllers.

Referring again to FIG. 10, the vehicle and its components illustrated in FIG. 1, FIG. 3, and FIG. 5 are referenced throughout the discussion of the method to facilitate understanding of various aspects of the present disclosure. The method of estimating the battery performance variables, specifically instantaneous and continuous current limits and power limits, in the hybrid electric vehicle may be implemented through a computer algorithm, machine executable code, or software instructions programmed into a suitable programmable logic device(s) of the vehicle, such as the vehicle control module, the hybrid control module, another controller in communication with the vehicle computing system, or a combination thereof. Although the various steps shown in the flowchart diagram 900 appear to occur in a chronological sequence, at least some of the steps may occur in a different order, and some steps may be performed concurrently or not at all.

At step 902, during a key-on event which allows the vehicle to be powered on, the vehicle computing system may begin powering up the one or more modules. The powering up of the one or more modules may cause variables related to the battery management system to initialize before enabling one or more algorithms used to control the battery at step 904.

The initialized parameters may be predetermined values or stored values at the last key off event. Before enabling the algorithms at a key-on event, the parameters should be initialized. For example, the battery management method may initialize several variables including, but not limited to, the battery terminal voltage, current limits, and/or other battery related parameters.

At 906, the system may measure the battery voltage outputs and current inputs using several types of sensors in real time. Once the system has received the battery voltage responses and current measurements, the system may process the received signals to calculate battery state variables, represented by voltage responses based on the fast and slow dynamics of the battery. The fast and slow dynamics voltage responses are captured using a two RC circuit model at step 908.

At step 910, the system may determine if the received current input and voltage outputs of the model are fast or slow dynamics. Based on the fast or slow dynamics, the system may determine whether to calculate power parameters based on instantaneous or continuous current limits. The instantaneous and continuous current limits may be calculated simultaneously using the equations (8) and (9).

At step 912, the system may compute instantaneous current limits. The instantaneous dynamics are based on the assumption that

$${τ}_{1} ≪ {τ}_{2} and \frac{{t}_{d}}{{τ}_{2}} ≪ 1.$$

The estimation errors for fast dynamics may be dampened in equation (8) for computing instantaneous current limits at step 910.

At step 914, the system may compute continuous current limits. The continuous dynamics are based on the assumption that

$$\frac{{t}_{d}}{{τ}_{1}} ≫ 1.$$

The estimation errors for fast dynamics may be dampened in equation (9) for computing continuous current limits at step 912.

At step 916, the system may calculate power limits for instantaneous and/or continuous current limits with two or more RC circuits in the equivalent model circuit using equations (10), (11a) and (11b). The calculated power limits may be used to determine the battery current commands from the battery controller to the battery pack.

At step 918, if the system detects a key-off event, the system may end the one or more algorithms used to manage the battery pack and/or the one or more battery cells. The vehicle computing system may have a vehicle key-off mode to allow the system to store one or more parameters in nonvolatile memory such that these parameters may be used by the system for the next key-on event at step 920.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle battery management system comprising:
a battery pack; and
at least one controller programmed to control operation of the battery pack according to first and second current limits that are based on state variables from an equivalent circuit model of the battery pack generated in response to terminal voltage and output current data associated with the battery pack, wherein a time duration of the second current limit is at least an order of magnitude greater than a time duration of the first current limit.

2. The system of claim 1, wherein the equivalent circuit model includes first and second RC circuits and wherein the first current limit is further based on parameters defining the first RC circuit and the second current limit is further based on parameters defining the second RC circuit.

3. The system of claim 2, wherein the second current limit is further based on at least one of the parameters defining the first RC circuit.

4. The system of claim 3, wherein the at least one of the parameters is a resistance of the first RC circuit.

5. The system of claim 2, wherein a time constant of the first RC circuit is less than a time constant of the second RC circuit.

6. The system of claim 1, wherein the at least one controller is further programmed to apply an Extended Kalman Filter to the terminal voltage data.

7. A vehicle battery management method comprising:
controlling operation of a battery pack according to first and second current limits that are based on state variables from an equivalent circuit model of the battery pack, wherein a time duration of the second current limit is at least an order of magnitude greater than a time duration of the first current limit.

8. The method of claim 7 further comprising generating the state variables in response to terminal voltage and output current data associated with the battery pack.

9. The method of claim 7, wherein the equivalent circuit model includes first and second RC circuits and wherein the first current limit is further based on parameters defining the first RC circuit and the second current limit is further based on parameters defining the second RC circuit.

10. The method of claim 9, wherein the second current limit is further based on at least one of the parameters defining the first RC circuit.

11. The method of claim 10, wherein the at least one of the parameters is a resistance of the first RC circuit.

12. The method of claim 9, wherein a time constant of the first RC circuit is less than a time constant of the second RC circuit.

13. A battery system comprising:
a plurality of battery cells; and
a controller programmed to
output a plurality of current limits for the cells, wherein each of the current limits has a different time duration and is based on state variables from an equivalent circuit model of the cells, and wherein the state variables are based on terminal voltage and output current data associated with the cells, and
control operation of the cells according to the current limits.

14. The system of claim 13, wherein the equivalent circuit model includes first and second RC circuits and wherein one of the current limits is further based on parameters defining the first RC circuit and another of the current limits is further based on parameters defining the second RC circuit.

15. The system of claim 14, wherein the another of the currents limit is further based on at least one of the parameters defining the first RC circuit.

16. The system of claim 15, wherein the at least one of the parameters is a resistance of the first RC circuit.

17. The system of claim 14, wherein a time constant of the first RC circuit is less than a time constant of the second RC circuit.
